(19) United States
(12) Patent Application Publication
(10) Pub. No.: US 2016/0233819 A1
(43) Pub. Date: Aug. 11, 2016

(54) MULTIPART ROOF HOOK AND FASTENING SYSTEM

(71) Applicant: Mounting Systems GmbH, Rangsdorf (DE)

(72) Inventor: Mark Redel, Blankenfelde-Mahlow (DE)

(21) Appl. No.: 14/950,749

(22) Filed: Nov. 24, 2015

(30) Foreign Application Priority Data
Nov. 26, 2014 (DE) 202014009488.8

(51) Int. Cl. H02S 20/23; E04D 13/00; F16M 13/02

(52) U.S. Cl. CPC H02S 20/23; F16M 13/02; E04D 13/00

(57) ABSTRACT

A multipart roof hook for connecting a profile rail to a roof substructure, has a fastening part and a connecting part. The fastening part is fastenable to the roof substructure and the connecting part is fastenable to the fastening part in order to produce a mounted state. The fastening part is a right-angled angle profile having a first and a second fastener limb, the second fastener limb has a first sawtooth profile on a side facing the first fastener limb, the connecting part has a first and a second connector limb which and are connected together by an intermediate section, the first connector limb has a second sawtooth profile on a side facing the intermediate section, and the first and second sawtooth profiles are configured to prevent a relative movement of the connecting part and of the fastening part and to allow relative movement in a non-mounted state.

### CROSS REFERENCE TO RELATED APPLICATION

This application claims priority under 35 USC §119 to German Patent Application No. 20 2014 009 488.8 filed on Nov. 26, 2014, which application is hereby incorporated by reference in its entirety.

### TECHNICAL FIELD

The invention relates to a multipart roof hook for connecting a profile rail to a roof substructure, and to a fastening system for a solar module arrangement.

### BACKGROUND OF THE INVENTION

Such roof hooks serve in particular as part of a fastening system for a solar module arrangement. As is known, solar modules, such as in particular photovoltaic modules or solar collectors, are frequently mounted on roofs. To this end, in-roof and on-roof systems are available in principle. While solar modules are mounted in place of roof tiles in the case of an in-roof system, they are arranged over the roof tiles in an on-roof system. This requires secure fastening of the solar modules to the roof structure, and to this end use is typically made of roof hooks, which are hooked in between the roof tiles and are fastened to the roof substructure.

In on-roof systems, solar modules are mounted at a great height and often on sloping roofs. Accordingly, it is desirable to have available solar module fastening systems which are as easy to handle as possible and can be mounted with few work steps. Roof hooks for solar module arrangements are already known from the prior art, for example as described in DE 10 2011 084 215 A1 and DE 20 2008 016 000 U1.

A roof hook according to the invention is specified in claim 1, and a fastening system having such a roof hook in claim 8. Advantageous configurations can be found in the dependent claims.

According to a first aspect, the invention relates to a multipart roof hook for connecting a profile rail to a roof substructure. In this case, the profile rail is configured in particular as part of a fastening system for a solar module arrangement. The roof hook has a fastening part which is fastenable to the roof substructure and a connecting part which is fastenable to the fastening part in order to produce a mounted state. The fastening part is a right-angled angle profile having a first and a second fastener limb, wherein the second fastener limb has a first sawtooth profile on a side facing the first fastener limb. The connecting part has a first and a second connector limb which have mutually parallel orientations and are connected together by an intermediate section. The first connector limb has in this case a second sawtooth profile on a side facing the intermediate section. The first sawtooth profile and the second sawtooth profile are configured to prevent a relative movement of the connecting part and of the fastening part under a pressure force applied to the second fastener limb and the first connector limb in the mounted state, and to allow a relative movement of the connecting part and of the fastening part with respect to one another in a non-mounted state.

As a result of the multipart design of the roof hook, the roof hook is usable for different strengths of roofing. At the same time, it is easy to set the desired spacings via displacement of the connecting part and of the fastening part with respect to one another, wherein the sawtooth profiles ensure that slipping is no longer possible in the mounted state. The roof hook according to the first aspect of the invention furthermore achieves a high load capacity with as little material usage as possible. Therefore, it also ensures particularly favourable load introduction into the roof substructure. Moreover, advantages arise in the production of the relatively easy-to-produce individual parts, which can then be assembled to form the multipart roof hook.

In the following text, embodiments of the roof hook are described.

In a preferred embodiment, in addition to the fastening part and the connecting part, the roof hook has a fastening means which is configured to fasten the fastening part to the connecting part and to exert the pressure force on the second fastener limb and the first connector limb in the mounted state. In particular bolts, slots, nuts, clip holders or the like are suitable as fastening means.

Advantageously, the first connector limb has a through-hole, in particular a slotted hole, in which the fastening means can easily be received.

In a further embodiment, the intermediate section is configured in a U-shaped or J-shaped manner when seen in side view. In a further embodiment, the intermediate section is configured in the form of a hollow-chamber profile. This embodiment allows a reduction in material with the same load-bearing capacity, and so particularly favourable load introduction into the roof substructure occurs.

In a further embodiment of the roof hook, the second connector limb has a sawtooth profile or a slotted hole. The combination of a sawtooth profile with a slotted hole on the second connector limb is also advantageous. With these embodiments, particularly easy mounting of the profile rail on the roof hook is possible.

Preferably, a hammerhead slot is formed on the second fastener limb. The hammerhead slot allows easy and secure fastening of the connecting part to the fastening part. In one embodiment, the fastening means is a cup square bolt. In another embodiment, a hexagon bolt with a nut is used.

In a preferred embodiment of the roof hook, the fastening part or the connecting part or both the fastening part and the connecting part is/are produced from aluminium.

According to a second aspect, the invention relates to a fastening system having a roof hook according to a first aspect of the invention or one of the embodiments thereof described in this application, and having a profile rail which is fastened to the roof hook. The fastening system shares the above-described advantages of the roof hook.

### BRIEF DESCRIPTION OF THE DRAWINGS

Further advantages and features of the invention are described in the following text in exemplary embodiments with reference to the appended drawing, in which

FIG. 1 shows an embodiment of a fastening part of a multipart roof hook according to the first aspect of the invention,

FIG. 2 shows an embodiment of a connecting part of a multipart roof hook according to the first aspect of the invention in a perspective view (FIG. 2a) and in a sectional view (FIG. 2b),

FIG. 3 shows an embodiment of a multipart roof hook according to the first aspect of the invention,

FIG. 4 shows an embodiment of a fastening system according to the second aspect of the invention.

### DETAILED DESCRIPTION

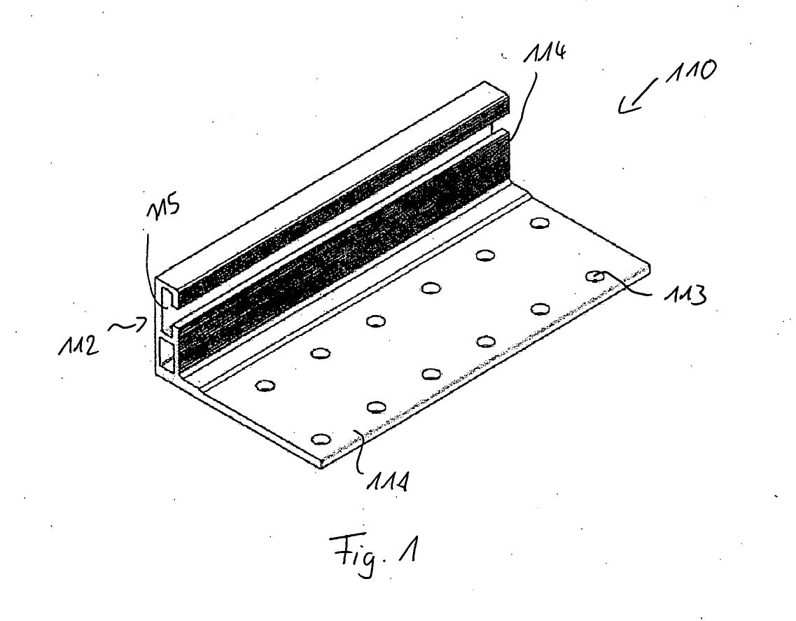

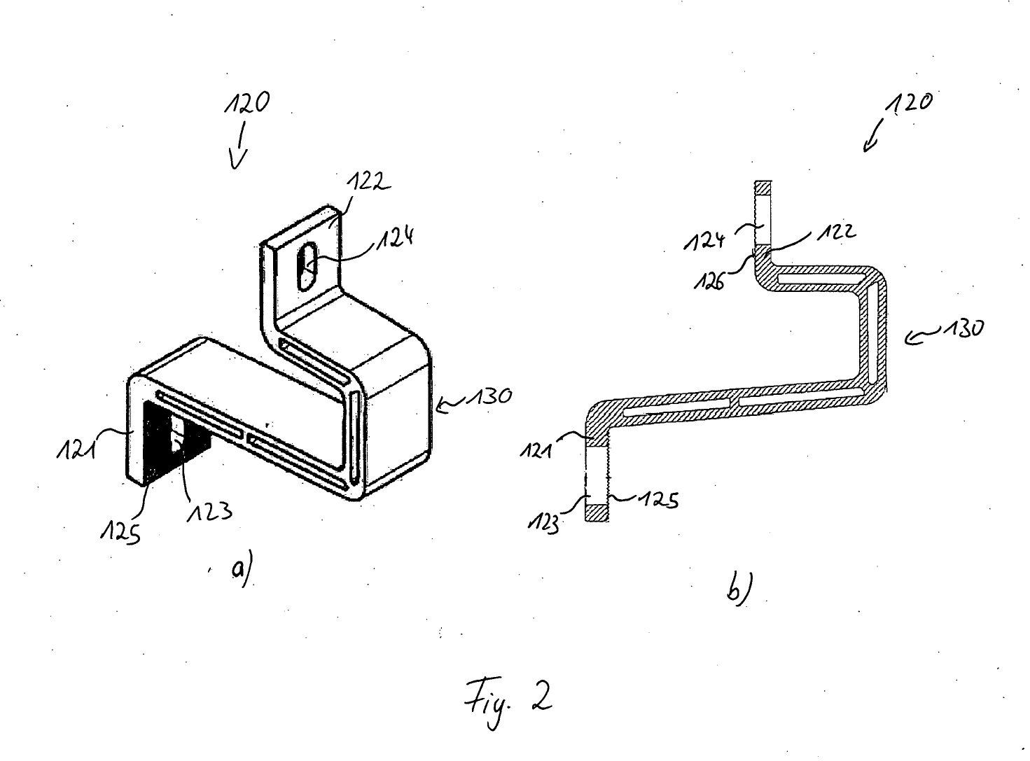

FIG. 1 shows a fastening part 110 of a multipart roof hook. The fastening part 110 is configured in the form of a right-angled angle profile and has a first fastener limb 111 and a second fastener limb 112. The first fastener limb 111 has a plurality of through-holes 113. For connecting to a roof substructure, fastening means, for example bolts, can be passed through the through-holes and so fasten the fastening part 110 to a roof substructure. The second fastener limb has a first sawtooth profile 114. Furthermore, a hammerhead slot 115 is arranged on the second fastener limb. In the mounted state of the roof hook, a connecting part, which is described in more detail in FIG. 2 below, is fastened to the fastening part 110. To this end, the connecting part has a second sawtooth profile.

The first sawtooth profile 114 and the second sawtooth profile are in this case arranged such that a relative movement of the connecting part and of the fastening part 110 with respect to one another is prevented under a pressure force exerted on the fastening part and the connecting part in the mounted state. By contrast, in a non-mounted state, a relative movement of the connecting part and of the fastening part 110 relative to one another is possible.

FIG. 2 shows an embodiment of a connecting part 120 of a multipart roof hook. In FIG. 2a, the connecting part 120 is illustrated in a perspective view and FIG. 2b illustrates a sectional view of the connecting part. The connecting part 120 has a first connector limb 121 and a second connector limb 122. In the embodiment illustrated in FIGS. 2a and 2b, both the first connector limb and the second connector limb have a slotted hole 123, 124. The first connector limb has a second sawtooth profile 125 on a side facing the intermediate section. The second connector limb 122 has a third sawtooth profile 126. The connecting part 120 is connectable to a fastening part in the multipart roof hook. In particular, the second fastener limb and the first connector limb 121 are connected together. Therefore, the second sawtooth profile 125 is embodied in a complementary manner to the first sawtooth profile. The connecting part 120 furthermore has an intermediate section 130, which is embodied as a J-shaped hollow chamber profile in the embodiment shown in the present case.

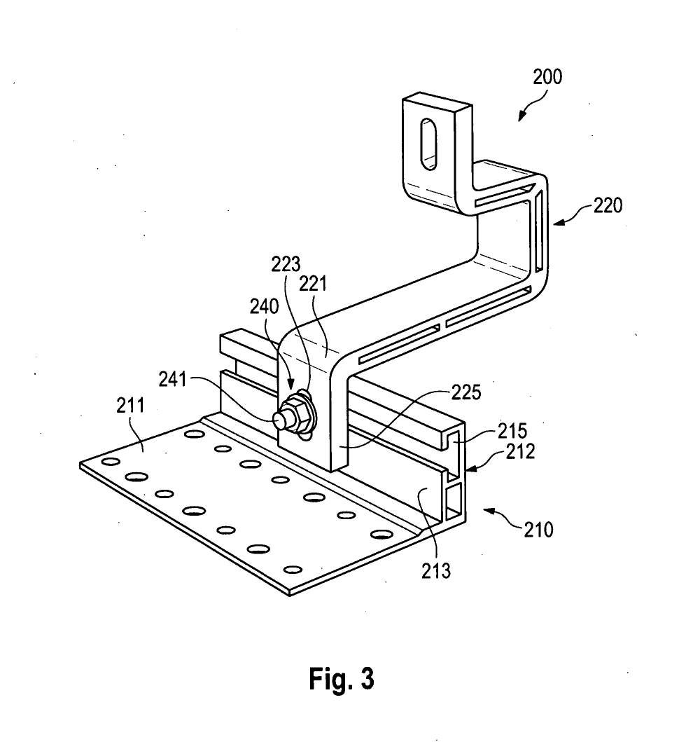

FIG. 3 shows an embodiment of a multipart roof hook 200 according to the first aspect of the invention. The roof hook 200 comprises a fastening part 210, a connecting part 220 and a fastening means 240. The fastening means fastens the fastening part 210 to the connecting part 220. In the embodiment shown, the fastening means 240 is a cup square bolt 241, the square neck of the cup square bolt being received in a hammerhead slot 215 arranged in the second fastener limb 212. The square neck affords the advantage that it cannot rotate in the hammerhead slot. The connecting part 220 has a slotted hole 223 in which the bolt 241 of the fastening means 240 is received. By tightening the bolt 241 of the fastening means 240, a pressure force is exerted on the second fastener limb 212 and the first connector limb 221. The first and second sawtooth profiles 213, 225 are in this case arranged such that, under the pressure force, a relative movement of the connecting part 220 and of the fastening part 210 is prevented. By positioning the fastening means 240 differently in the slotted hole 223, it is possible to set different spacings of the connecting part with respect to the first fastener limb 211 and thus to the roof substructure.

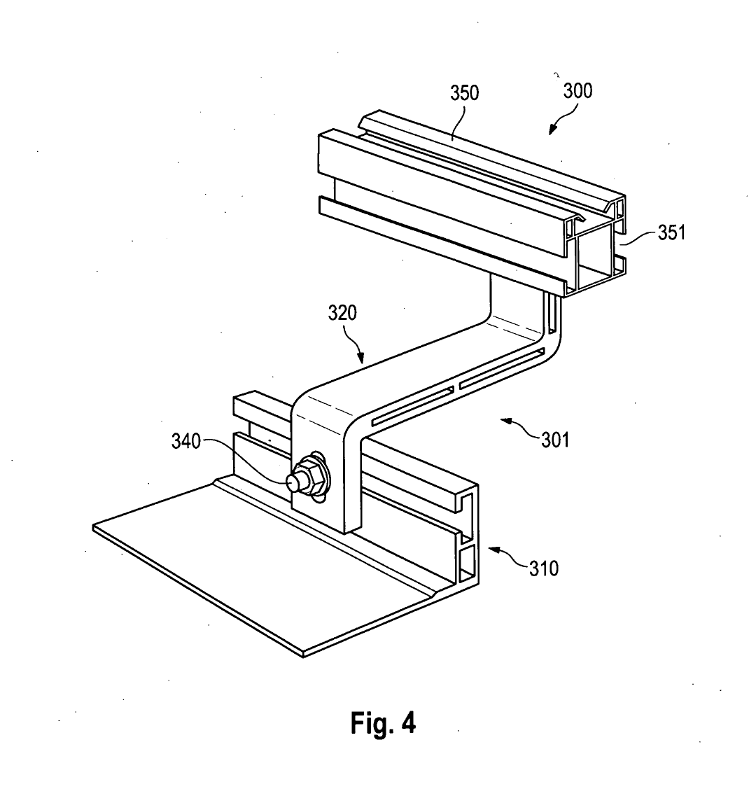

FIG. 4 shows an embodiment of a fastening system 300 according to the second aspect of the invention. The fastening system 300 comprises a roof hook 301 having a connecting part 320, a fastening part 310 and a fastening means 340. Fastened to the second connector limb of the connecting part 320 is a profile rail 350. The profile rail has a hammerhead slot 351. The profile rail 350 is fastened to the connecting part via a through-hole in the second connector limb by means of a fastening means (not illustrated here) in the form of a bolt having a slot nut.

In general, it should be noted that bolts, slots, nuts, clip holders or the like are suitable as fastening means.

What it claimed is:

1. A multipart roof hook for connecting a profile rail, in particular as part of a fastening system for a solar module arrangement, to a roof substructure, comprising:
a fastening part which is fastenable to the roof substructure, and
a connecting part which is fastenable to the fastening part in order to produce a mounted state,
characterized in that
the fastening part is a right-angled angle profile having a first and a second fastener limb,
the second fastener limb has a first sawtooth profile on a side facing the first fastener limb,
the connecting part has a first and a second connector limb which have mutually parallel longitudinal orientations and are connected together by an intermediate section, and
the first connector limb has a second sawtooth profile on a side facing the intermediate section, and in that
the first sawtooth profile and the second sawtooth profile are configured to prevent a relative movement of the connecting part and of the fastening part under a pressure force applied to the second fastener limb and the first connector limb in the mounted state, and to allow a relative movement of the connecting part and of the fastening part with respect to one another in a non-mounted state.

2. The roof hook according to claim 1, which has a fastening means which is configured to fasten the fastening part to the connecting part and to exert the pressure force on the second fastener limb and the first connector limb in the mounted state.

3. The roof hook according to claim 2, in which the first connector limb has a slotted hole.

4. The roof hook according to claim 3, in which the intermediate section is configured in a U-shaped or J-shaped manner when seen in side view.

5. The roof hook according to claim 4, in which the intermediate section is configured in the form of a hollow-chamber profile.

6. The roof hook according to claim 5, in which the second connector limb has a sawtooth profile or a slotted hole or a sawtooth profile and a slotted hole.

7. The roof hook according to claim 6, in which a hammerhead slot is formed on the second fastener limb.

8. The roof hook according to claim 7, in which the fastening means is a cup square bolt.

9. The roof hook according to claim 8, in which the fastening part or the connecting part is produced from aluminium.

10. A fastening system comprising at least one roof hook according to claim 1 and at least one profile rail which is fastened to the roof hook.

11. The roof hook according to claim 1, in which the first connector limb has a slotted hole.

12. The roof hook according to claim 1, in which the intermediate section is configured in a U-shaped or J-shaped manner when seen in side view.

13. The roof hook according to claim 1, in which the intermediate section is configured in the form of a hollow-chamber profile.

14. The roof hook according to claim 1, in which the second connector limb has a sawtooth profile or a slotted hole or a sawtooth profile and a slotted hole.

15. The roof hook according to claim 1, in which a hammerhead slot is formed on the second fastener limb.

16. The roof hook according to claim 2, in which the fastening means is a cup square bolt.

17. The roof hook according to claim 1, in which the fastening part or the connecting part is produced from aluminium.
